(19) United States
(12) Patent Application Publication
(10) Pub. No.: US 2025/0005426 A1
(43) Pub. Date: Jan. 2, 2025

(54) SYSTEM AND METHOD TO TRAIN AND EVALUATE A DEEP-LEARNING SYSTEM ON MULTIPLE GROUND-TRUTH SOURCES SUBJECT TO MEASUREMENT ERRORS

(71) Applicant: Robert Bosch GmbH, Stuttgart (DE)

(72) Inventors: Luca Bondi, Pittsburgh, PA (US); Shabnam Ghaffarzadegan, Livermore, CA (US); Samarjit Das, Wexford, PA (US)

(21) Appl. No.: 18/214,549

(22) Filed: Jun. 27, 2023

(51) Int. Cl. G06N 20/00

(52) U.S. Cl. CPC G06N 20/00

(57) ABSTRACT

A method of training a machine learning (ML) model includes obtaining a dataset that includes first training data obtained using two or more ground truth sensing systems and second training data obtained using a prediction sensing system configured to implement the ML model, determining a loss function based on the first training data, the loss function defining a region of zero loss based on a minimum and a maximum of the first training data, calculating, using the ML model, a prediction output based on the second training data, calculating, using the loss function, a loss of the ML model based on the prediction output, and updating the ML model based on the calculated loss.

The present disclosure relates to computer systems configured to implement artificial intelligence, including neural networks.

### BACKGROUND

Internet of Things (IoT) systems based on machine and deep-learning algorithms are becoming pervasive in both industrial and consumer applications. The commercial success of such systems is strongly related to meeting expectations for accuracy, precision, recall, and coverage. The development of highly accurate deep-learning systems is directly influenced by the availability of a large and varied collection of training and evaluation data. A wide variety of evaluation data is necessary to assess the performance of a system before it is manufactured and deployed. A large amount of labeled data is key to training complex and large deep-learning models capable of meeting the desired levels of performance.

### SUMMARY

Aspects of the present disclosure include a method of training a machine learning (ML) model includes obtaining a dataset that includes first training data obtained using two or more ground truth sensing systems and second training data obtained using a prediction sensing system configured to implement the ML model, determining a loss function based on the first training data, the loss function defining a region of zero loss based on a minimum and a maximum of the first training data, calculating, using the ML model, a prediction output based on the second training data, calculating, using the loss function, a loss of the ML model based on the prediction output, and updating the ML model based on the calculated loss.

In other aspects, the ground truth sensing systems include at least one of a camera system, a radar system, and a photocell system and the prediction sensing system includes at least one audio sensor. The ML model is configured to detect features in an audio stream of data. Determining the loss function includes defining the region of zero loss between a lower bound based on the minimum of the first training data and an upper bound based on the maximum of the first training data. The method further includes determining a correctness function based on the first training data. The correctness function is configured to output a first value in response to the prediction output being within a predetermined tolerance of the region of zero loss and output a second value in response to the prediction output not being within the predetermined tolerance of the region of zero loss. The method further includes calculating an accuracy of the ML model using the correctness function and updating the ML model further based on the calculated accuracy. The two or more ground truth sensing systems are configured to visually detect an object in a first time interval and the prediction sensing system is configured to detect audio features associated with the object in the first time interval.

A system for training a machine learning (ML) model includes loss function circuitry configured to receive a dataset that includes first training data obtained using two or more ground truth sensing systems and determine a loss function based on the first training data, wherein the loss function defines a region of zero loss based on a minimum and a maximum of the first training data and ML circuitry configured to implement the ML model. Implementing the ML model includes receiving second training data obtained using a prediction sensing system configured to implement the ML model and calculating, using the ML model, a prediction output based on the second training data. The loss function circuitry is further configured to calculate, using the loss function, a loss of the ML model based on the prediction output. The ML circuitry is configured to update the ML model based on the calculated loss.

In other aspects, the ground truth sensing systems include at least one of a camera system, a radar system, and a photocell system and the prediction sensing system includes at least one audio sensor. The ML model is configured to detect features in an audio stream of data. To determine the loss function, the loss function circuitry is configured to define the region of zero loss between a lower bound based on the minimum of the first training data and an upper bound based on the maximum of the first training data. The system further includes correctness function circuitry configured to determine a correctness function based on the first training data. The correctness function is configured to output a first value in response to the prediction output being within a predetermined tolerance of the region of zero loss and output a second value in response to the prediction output not being within the predetermined tolerance of the region of zero loss. The correctness function circuitry is configured to calculate an accuracy of the ML model using the correctness function, and wherein the ML circuitry is configured to and update the ML model further based on the calculated accuracy. The two or more ground truth sensing systems are configured to visually detect an object in a first time interval and the prediction sensing system is configured to detect audio features associated with the object in the first time interval.

A computing device is configured to implement and train a machine learning (ML) model. The computing device includes a processing device configured to execute instructions stored in memory to obtain a dataset that includes first training data obtained using two or more ground truth sensing systems and second training data obtained using a prediction sensing system configured to implement the ML model, determine a loss function based on the first training data, wherein the loss function defines a region of zero loss based on a minimum and a maximum of the first training data, calculate, using the ML model, a prediction output based on the second training data, calculate, using the loss function, a loss of the ML model based on the prediction output, and update the ML model based on the calculated loss.

In other aspects, a system includes the computing device and further includes the two or more ground truth sensing systems and the prediction sensing system. The ground truth sensing systems include at least one of a camera system, a radar system, and a photocell system and the prediction sensing system includes at least one audio sensor. The ML model is configured to detect features in an audio stream of data. Determining the loss function includes defining the region of zero loss between a lower bound based on the minimum of the first training data and an upper bound based on the maximum of the first training data. The processing device is further configured to execute instructions stored in memory to determine a correctness function based on the first training data. The correctness function is configured to output a first value in response to the prediction output being within a predetermined tolerance of the region of zero loss and output a second value in response to the prediction output not being within the predetermined tolerance of the region of zero loss, calculate an accuracy of the ML model using the correctness function, and update the ML model further based on the calculated accuracy. The two or more ground truth sensing systems are configured to visually detect an object in a first time interval and the prediction sensing system is configured to detect audio features associated with the object in the first time interval.

### BRIEF DESCRIPTION OF THE DRAWINGS

FIG. 1 generally illustrates a system for training a neural network according to the principles of the present disclosure.

FIG. 2 generally illustrates a computer-implemented method for training and utilizing a neural network according the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIG. 4A shows a training system configured to train a machine learning model using a loss function and a correctness function according to the principles of the present disclosure.

FIG. 4B shows an example loss function according to the principles of the present disclosure.

FIG. 4C shows an example correctness function according to the principles of the present disclosure.

FIG. 4D illustrates steps of an example method for training a machine learning model using a loss function and a correctness function according to the principles of the present disclosure.

FIG. 5 depicts a schematic diagram of an interaction between a computer-controlled machine and a control system according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In development of data for training machine-learning (ML) models (which, as used herein, includes deep-learning models), data collection and labeling, particularly sound data, is a laborious, costly, and time-consuming venture, which may represent a major bottleneck in most current machine-learning pipelines. Manual data labeling is particularly time consuming, leading to high costs and/or limited datasets. For example, humans use a variety of sound cues from an environment in everyday life decision making. Increasingly, developers are attempting to incorporate such decision making in various machine-learning models. While techniques for using a machine-learning model to understand human speech is relatively ubiquitous, using an ML model to understand non-speech environmental sounds is a comparably younger field and a fast-growing topic of interest.

Most recent advancements in deep learning technology for vision and text come from the access to a large amount of labeled data. However, collecting and strongly labeling data, such as audio data (e.g., including labeling an event type as well as a start and an end of the event in an audio sample), may be relatively difficult. Audio data collection in general is a challenging task, due to a substantially unlimited audio vocabulary in real-world scenarios, which may render it essentially impossible to predict the lexicon of a given task.

Unlike spoken words that use a limited set of alphabets, variations in environmental sounds are unlimited. As a result, collecting specific sounds in a pre-set environment is not realistic. Hence, most audio data collection is captured in a continuous setting, and later, human annotators extract and label the desired audio events. Such labeling may be relatively time consuming (e.g., because the annotators may listen to hours of data to find the events of interest or target events). Further, after finding the target events, accurately labeling the start and the end of an audio event may be noisy and subjective due to the transient nature of the signal that typically lacks sharp boundaries.

Another common way to collect audio data is using available data (e.g., from various public sources). However, such data is typically of a low quality, and associated labels for such data may often be created automatically using the title of the audio or video file associated with the data. These labels are sometimes noisy and, typically, are weak labels (e.g., a section of the audio file is labeled as an audio event, but the exact time boundaries of the event are not specified). This typically poses a number of challenges for traditional training of ML models.

When automated collection of ground-truth data (i.e., actual known data used to train ML models) is feasible, the amount of effort required to generate a varied and consistent dataset can be reduced. However, automated ground truth collection comes at a cost in terms of precision, and multiple automatic systems (e.g., multiple, different sensors and/or types of sensors) employed to collect ground-truth data about the same phenomenon each may produce slightly different results.

Systems and methods according to the present disclosure are configured to implement automated collection of ground-truth data using multiple different sensors. The collected ground-truth data is used to evaluate and train an ML or deep-learning model (e.g., a deep-learning model for a regression task). For example, the ground-truth data is used to obtain a loss function and a correctness function for training an ML model. A loss function is used to drive a training process by providing feedback on how close the current predictions of the model are to available ground truth data. Conversely, the correctness function measures performance of the model (e.g., accuracy, precision, recall, etc. of the model). Accordingly, systems and methods of the present disclosure obtain and implement loss and correctness functions configured to receive and train the ML model based on multiple automatically-collected ground-truth measurements for regression tasks.

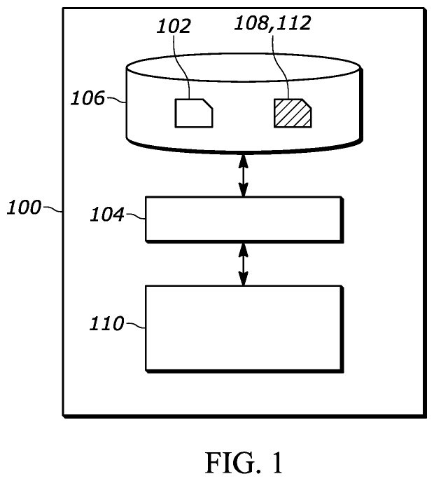

FIG. 1 shows a system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

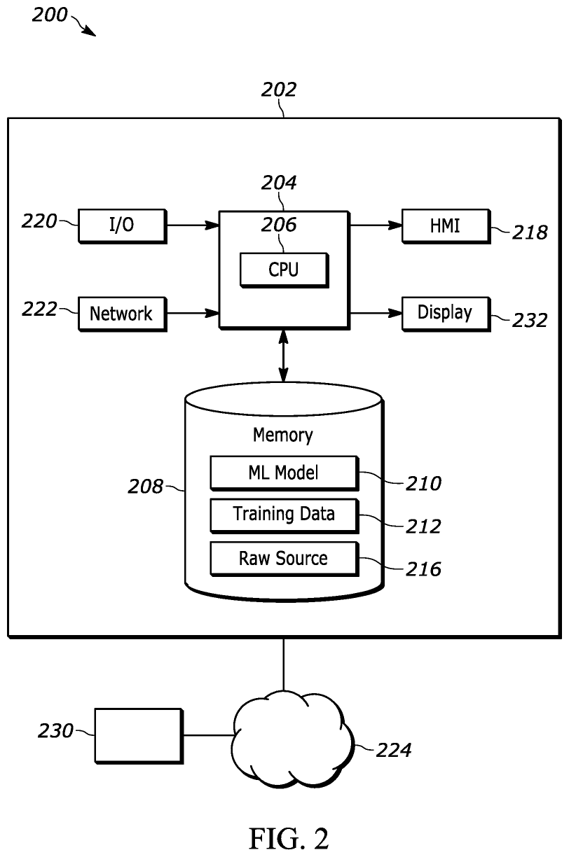

FIG. 2 depicts a data annotation/augmentation system 200 configured to (and/or including circuitry configured to) implement a system for annotating and/or augment data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. For example, the training dataset 212 according to the present disclosure may include multiple automatically-collected ground-truth measurements and associated data. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

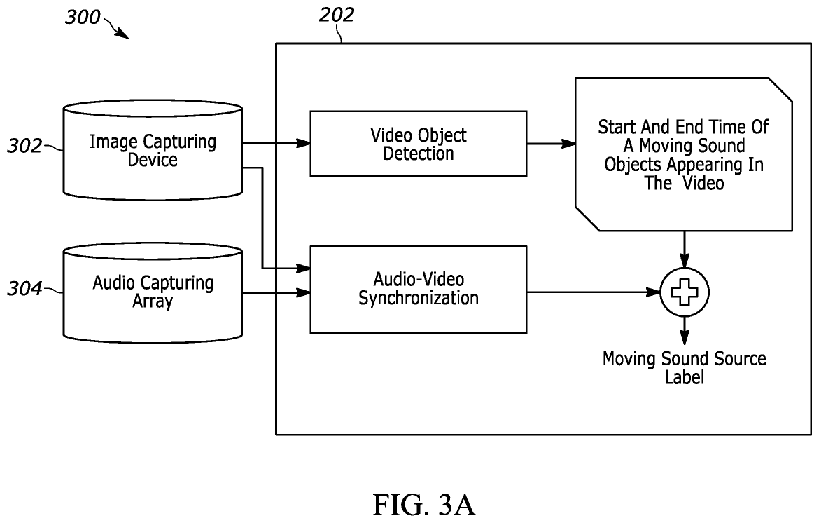

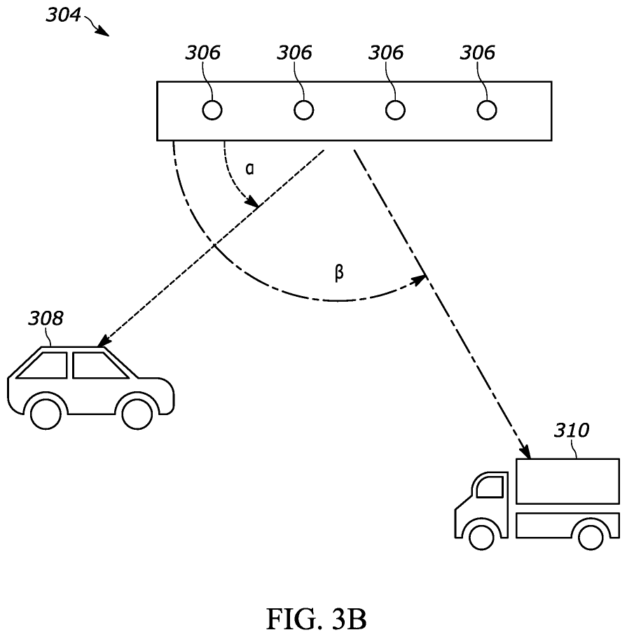

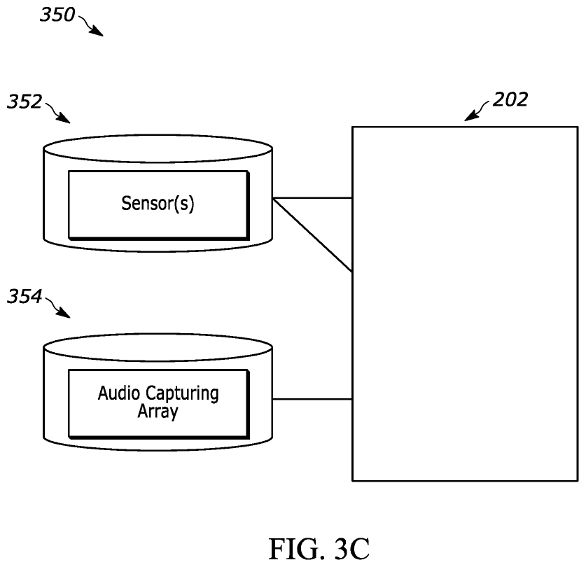

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 6-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 6-11.

Any of the systems described above and/or below in more detail may be configured to implement automated collection of ground-truth data using multiple different sensors to train a machine or deep learning model according to the present disclosure. In one example, an Internet of Things (IoT) system may be configured to count the number of vehicles passing by a particular point of interest (e.g., on a road) based on inputs from audio sensors (e.g., one or more microphones). Typically, verifying the accuracy of the system includes manually counting the number of vehicles (i.e., by a user listening to the corresponding recorded audio data). However, manually counting the number of vehicles by listening to recorded audio data is very time consuming and prone to errors. As an alternative to manual counting, systems described herein use multiple ground-truth sensors (e.g., a radar, a camera, a photocell, etc.) in a same location as the microphone or microphone array to obtain the number of passing vehicles using different types of sensing systems (e.g., automatic sensing systems). While each sensing system may provide different counts/estimates of the number of vehicles (e.g., due to different measurement errors, sensitivity, etc.), systems and methods as described below in more detail are configured to use data collected from the different sensing systems to obtain a loss function and a correctness function for accurately training an ML model, such as an ML model that implements a deep-learning algorithm.

Table 1 illustrates example vehicle counts (e.g., labels applied to detected events) from three different sensing systems (e.g., a radar system, a camera system, and a photocell system) in three different time periods or intervals (1, 2, and 3).

TABLE 1
Example of automatically collected labels from multiple systems

| Time | Radar | Camera | Photocell |
|---|---|---|---|
| interval | count | count | count |
| 1 | 14 | 15 | 13 |
| 2 | 11 | 11 | 11 |
| 3 | 8 | 12 | 9 |

In the context of a regression task where the goal is to count a finite number of elements, it is typically assumed that the ground truth is a single value for each time interval. A regression loss function (e.g., mean squared error, mean absolute error, etc.) can then be used to train the deep-learning algorithm based on the results of the different sensing systems. When ground-truth data is only available from multiple sensing systems subject to measurement errors (i.e., and not available from manual counting results), a loss function and correction function may be obtained based on the results of the sensing systems to train the deep-learning algorithm as described below in more detail.

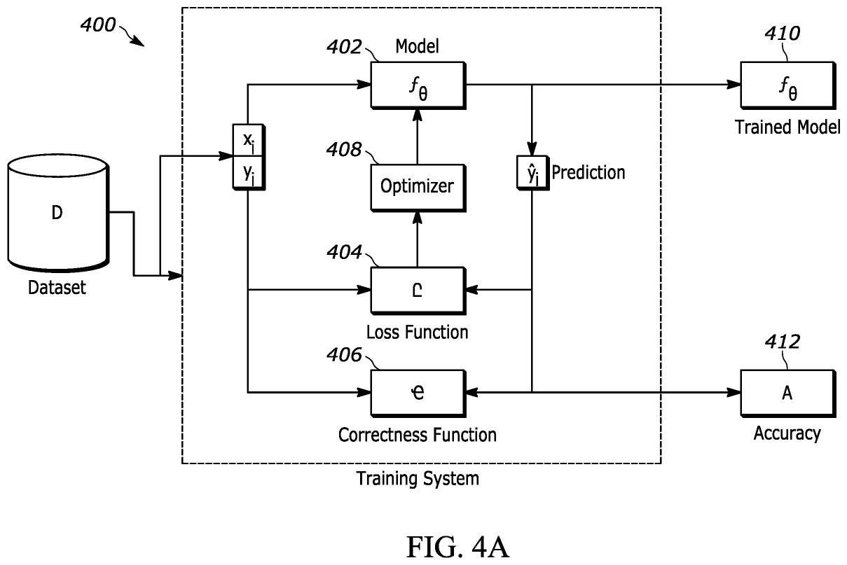

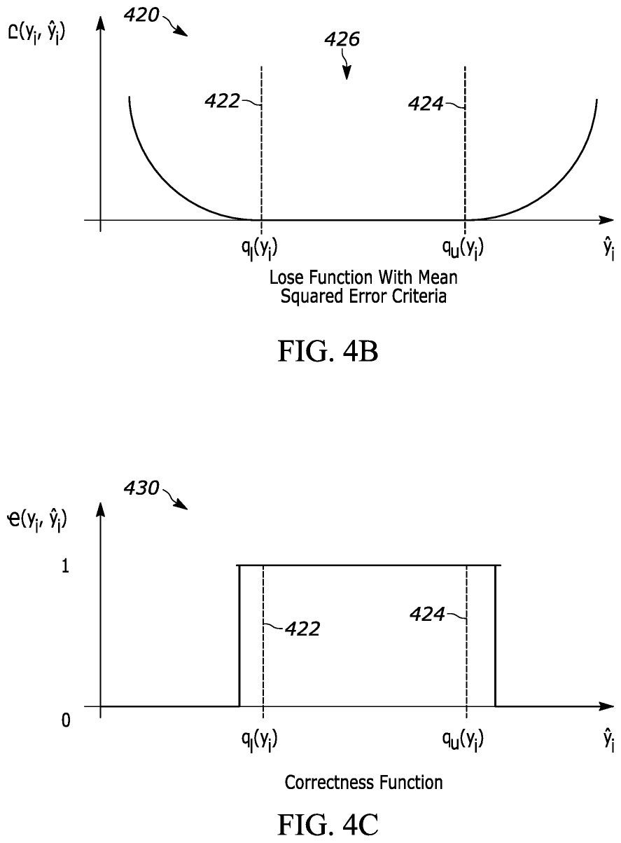

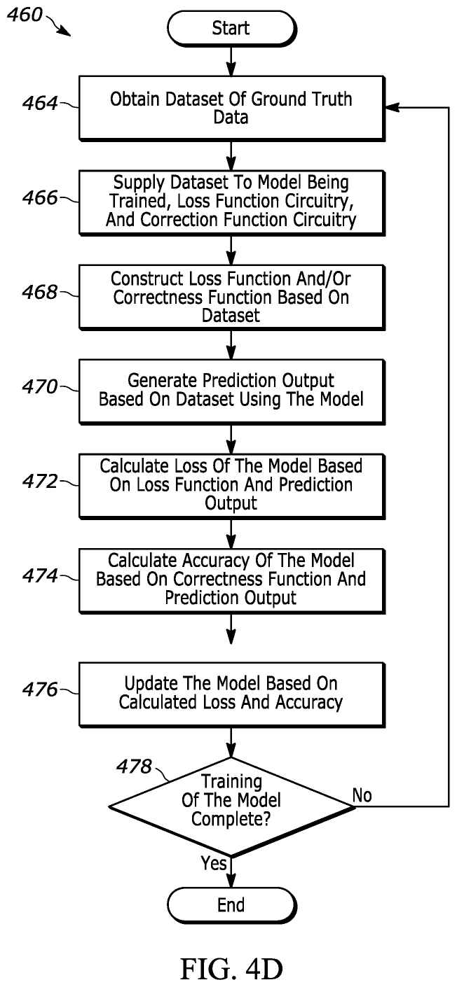

FIG. 4A shows a training system 400 configured to train an ML model 402 (e.g., implemented using ML circuitry, such as a processing device or other circuitry configured to implement an ML model) using a loss function (e.g., a loss function defined using loss function circuitry 404) and a correctness function (e.g., a correctness function defined using a correctness function circuitry 406) according to the present disclosure. For example only, the loss function circuitry 404 and the correctness function circuitry 406 may correspond to circuitry, such as a processing device configured to executed instructions stored in memory, configured to construct loss and correctness functions based on lower and upper bounds of the ground truth data as described below in more detail. ML circuitry configured to implement the ML model 402, the loss function circuitry 404, the correctness function circuitry 406, and/or other components of the training system 400 may be implemented using same or different circuitry.

The training system 400 may be configured to train an ML implemented by any of the systems described herein, such as the systems 100, 200, 300, etc. For example, given a dataset [symbol] ={(xᵢ, yᵢ), i∈[1, N]} where N is a total number of samples, xᵢ is an input signal for an i-th sample, yᵢ={yᵢ^{j}, j∈[1, M]} is a collection of ground truth measurements for an i-th sample from M different systems, and yᵢ^{j}∈Z⁺ is a ground-truth counting (positive integer numbers including zero) provided by a j-th measurement system for the i-th sample. With reference to Table 1, the dataset (e.g., training data) supplied to the training system includes the vehicle counts from the three different sensing systems and time intervals. In other words, yᵢ is a collection of respective ground truth measurements from each of the radar system, the camera system, and the photocell system for an input sample in one of the intervals 1, 2, 3, etc. Conversely, yᵢ^{j}∈Z⁺ corresponds to data obtained by a sensing system to be used with the model 402 (e.g., an audio sensor such as a microphone).

The training system 400 is configured to train a deep-learning algorithm or system f_{θ} through an optimizer 408 via back-propagation, minimizing a loss function

$$\frac{1}{N} {\sum }_{i = 1}^{N} ℒ ( {y}_{i} , {\hat{y}}_{i} ) ,$$

where ŷᵢ=f_{θ}(xᵢ) corresponds to a prediction of the model 402 for the i-th sample under a set of learned weights θ. For example, the optimizer 408 implements an algorithm configured to find a minimum of the loss function. An accuracy of the model 402 may be defined as

$$𝒜 = \frac{1}{N} {\sum }_{i = 1}^{N} 𝒞 ( {y}_{i} , {\hat{y}}_{i} ) ,$$

where [symbol] (yᵢ, ŷᵢ) is a correctness function that returns 1 when the prediction is correct and 0 when the prediction is not correct. As used herein, correctness of the prediction is based on a comparison between the prediction of the model 402 for a given time interval and a threshold range. Accordingly, the training system 400 obtains (e.g., outputs) a trained model 410 and a corresponding accuracy 412.

FIG. 4B shows an example loss function 420 according to the present disclosure. The loss function 420 is plotted as a loss function [symbol] (yᵢ, ŷᵢ) versus the predicted outputs (counts) ŷᵢ. Although shown as a loss function based on mean squared error criteria, the principles of the present disclosure may be implemented using other types of loss functions (e.g., absolute error). In one example, the loss function [symbol] (yᵢ, ŷᵢ) is configured to be derivable to allow the use of gradient-based back-propagation algorithms, such as stochastic gradient descent, as part of an optimization process implemented by the optimizer 408. Given the M ground truth measurements for a sample i, the loss function 420 defines two auxiliary functions qₗ(yᵢ) and qᵤ(yᵢ) whose outputs are respectively lower and upper bounds 422 and 424 for the ground truth obtained from the collection of measurements.

For example, the lower bound 422 corresponds to a lowest value from any of the sensing systems that obtained the ground truth data shown in Table 1 (e.g., 13 for time interval 1) and the upper bound corresponds to a highest value from any of the sensing systems (15 for the same time interval 1). In other words, for the time interval 1, the loss function 420 for the time interval 1 defines a loss of 0 for a region 426 between the lower bound 422 and the upper bound 424 and exponentially increasing values in regions less than the lower bound 422 and greater than the upper bound 424. In this manner, the loss function 420 of the present disclosure is based on predicted outputs (counts) ŷᵢ outside of the region 426 defined by the lower bound 422 and the upper bound 424. Possible implementations for qₗ include, but are not limited to, a minimum across all yᵢ values for a given time interval and a t quantile on yᵢ with t<0.5. Similarly, possible implementations for qᵤ include, but are not limited to, a maximum across all yᵢ values for a given time interval and at quantile on yᵢ with t>0.5.

Accordingly, the loss function 420 as shown in FIG. 4B may be defined as:

$$ℒ ( {y}_{i} , {\hat{y}}_{i} ) = \{ \begin{matrix}ℓ ( {q}_{l} ( {y}_{i} ) , {\hat{y}}_{i} ) & if {\hat{y}}_{i} < {q}_{l} ( {y}_{i} ) \\ ℓ ( {q}_{u} ( {y}_{i} ) , {\hat{y}}_{i} ) & if {\hat{y}}_{i} > {q}_{u} ( {y}_{i} ) \\ 0 & otherwise\end{matrix}$$

Table 2 illustrates loss values obtained for model outputs as compared to the ground truth data of Table 1. For example, Table 2 defines lower bounds qₗ(yᵢ) and upper bounds qᵤ(yᵢ) as respective minimums and maximums across yᵢ values and defines l as a squared error function.

TABLE 2
Example of loss obtained based on ground truth data from multiple systems

| | | Ground | Ground | | |
|---|---|---|---|---|---|
| | Ground | truth lower | truth upper | Model | |
| Time | truth | bound | bound | output | Loss |
| interval | yᵢ | qₗ(yᵢ) | qᵤ(yᵢ) | ŷᵢ | [symbol] (yᵢ, ŷᵢ) |
| 1 | 14, 15, 13 | 13 | 15 | 11 | [symbol] (13, 11) = (13 − 11)² = 4 |
| 2 | 11, 11, 11 | 11 | 11 | 12 | [symbol] (11, 12) = (11 − 12)² = 1 |
| 3 | 8, 12, 9 | 8 | 12 | 10 | 0 |

For example, for the time interval 1 and ground truth data between 13 and 15, a model output of 11 results in a loss of 4. For the time interval 2 and ground truth data 11 (i.e., all three sensing systems obtaining the same ground truth count), a model output of 12 results in a loss of 1. Conversely, for the time interval 3 and ground truth data between 8 and 12, a model output of 10 results in a loss of 0. In other words, since the model output corresponds to a value between the lower bound of 8 and the upper bound of 12, the loss function returns a loss of 0.

FIG. 4C shows an example correctness function 430 according to the present disclosure. The correctness function 430 is plotted as a correctness function [symbol] (yᵢ, ŷᵢ) versus the predicted outputs (counts) ŷᵢ. The correctness function 430 is an indicator function that returns a value of 1 when the predicted output ŷᵢ is considered to be correct. As used herein, “correct” corresponds to within or within a tolerance value of a range defined by the lower bound 422 and the upper bound 424. Since there is no single ground truth value, the correctness function may be defined as:

$$𝒞 ( {y}_{i} , {\hat{y}}_{i} ) = \{ \begin{matrix}1 if ( {\hat{y}}_{i} > {q}_{l} ( {y}_{i} ) * ( 1 - α ) ) ∧ ( {\hat{y}}_{i} < {q}_{u} ( {y}_{i} ) * ( 1 - α ) ) \\ 0 otherwise\end{matrix} ,$$

where α is a tolerance value (e.g., α=0.05 for a 5% tolerance). The correction function 430 defined above as [symbol] (yᵢ, ŷᵢ) considers any prediction within the lower bound 422 (qₗ(yᵢ)) and the upper bound 424 (qᵤ(yᵢ)) with a tolerance of a to be correct.

Table 3 illustrates correctness values obtained for model outputs as compared to the ground truth data of Table 1. For example, Table 3 defines correctness in view of the lower bounds qₗ(yᵢ) and upper bounds qᵤ(yᵢ) as respective minimums and maximums across y; values and as further modified by α tolerance a of 0.1.

TABLE 3
Example of correctness obtained based on ground truth data from multiple systems

| | Ground | Ground truth lower | Ground truth upper | Model | |
|---|---|---|---|---|---|
| Time | truth | bound with tolerance | bound with tolerance | output | Correctness |
| interval | yᵢ | qₗ(yᵢ) * (1 − α) | qᵤ(yᵢ) * (1 + α) | ŷᵢ | [symbol] (yᵢ, ŷᵢ) |
| 1 | 14, 15, 13 | 13 * 0.9 = 11.7 | 15 * 1.1 = 16.5 | 11 | 0 |
| 2 | 11, 11, 11 | 11 * 0.9 = 9.9 | 11 * 1.1 = 12.1 | 12 | 1 |
| 3 | 8, 12, 9 | 8 * 0.9 = 7.2 | 12 * 1.1 = 13.2 | 10 | 1 |

For example, for the time interval 1 and ground truth data between 13 and 15, a model output of 11 results in a correctness of 0 since 11 is outside of a range defined by the bounds 13 and 15 and the tolerance 0.1. For the time interval 2 and ground truth data 11, a model output of 12 results in a correctness of 1 since 12 is within a tolerance of 0.1 of 11. For the time interval 3 and ground truth data between 8 and 12, a model output of 10 results in a correctness of 1 since 10 is within a range defined by the bounds of 8 and 12 (with or without the tolerance of 0.1 applied to the bounds).

FIG. 4D illustrates steps of an example method 460 for training a machine learning model using a loss function and a correctness function according to the principles of the present disclosure. For example, steps of the method 460 may be performed by any of the systems described herein. At 464, the method 460 obtains a dataset of ground truth data (“training data”) by using multiple sensing systems as described above. The dataset and corresponding training data includes both ground truth data obtained by the multiple ground truth sensing systems (e.g., camera, radar, and photocell systems) and sensed data obtained by a prediction sensing system (e.g., a microphone) configured to be used with/implement the model subsequent to training (i.e., the trained model 410). Training data obtained using the type of sensing system configured to implement the ML model may be referred to as prediction training data. For example only, the dataset may include ground truth data obtained by multiple (e.g., n) ground truth sensing systems, such as first, second, . . . , and nth ground truth sensing systems and one or more prediction sensing systems.

Although described herein as using different types of sensing systems, in some examples one or more of the sensing systems may correspond to a same type of sensing system (e.g., multiple camera systems, multiple radar systems, etc.). At 466, the method 460 supplies the dataset to a model (e.g., the ML model 402) being trained, loss function circuitry (e.g., the loss function circuitry 404), and correctness function circuitry (e.g., the correctness function circuitry 406).

At 468, the method 460 constructs a loss function and/or a correctness function based on the ground truth data (e.g., using the loss function circuitry 404 and the correctness function circuitry 406). At 470, the method 460 (e.g., the ML model 402) generates a prediction output based on the prediction training data in the dataset. At 472, the method 460 (e.g., the loss function circuitry 404) calculates and outputs a loss of the model based on the prediction output (e.g., by using the prediction output as an input to the loss function) and provides the calculated loss to the model 402. In some example, the calculated loss is provided to the model 402 subsequent to processing by the optimizer 408. At 474, the method 460 (e.g., the correctness function circuitry 406) calculates and outputs an accuracy of the model 402 based on the prediction output (e.g., by using the prediction output as an input to the correctness function).

At 476, the method 460 updates the model 402 based on the calculated loss and accuracy. At 478, the method 460 determines whether training of the model 402 is complete. For example, the method 460 determines whether the training is complete based on a desired loss and accuracy of the model 402, such as an average loss for a predetermined interval or number of intervals being below a loss threshold, an average accuracy for a predetermined interval or number of intervals being above an accuracy threshold, etc. If true, the method 460 outputs the trained model 410 and ends. If false, the method 460 proceeds to 464 to continue to train the model 402.

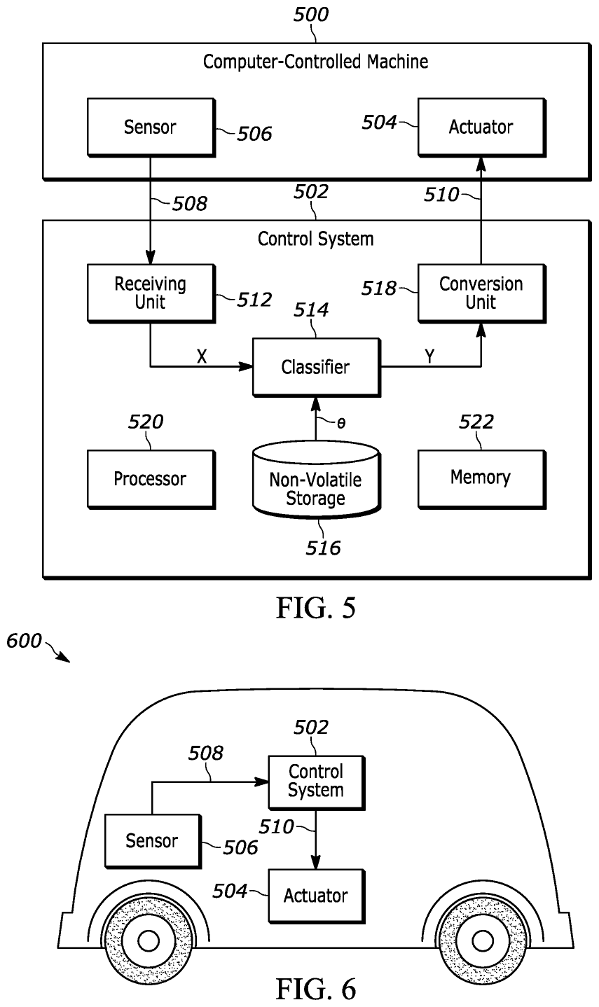

FIGS. 5-11 depict example systems and devices that may implement systems and methods according to the present disclosure. FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

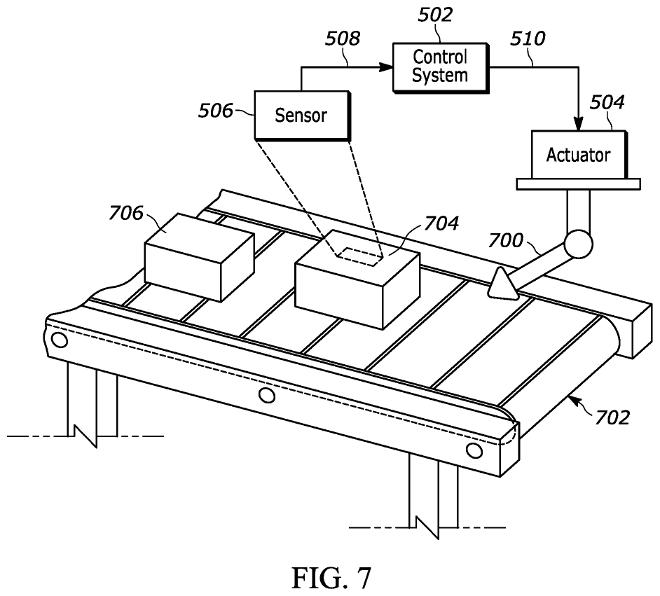

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

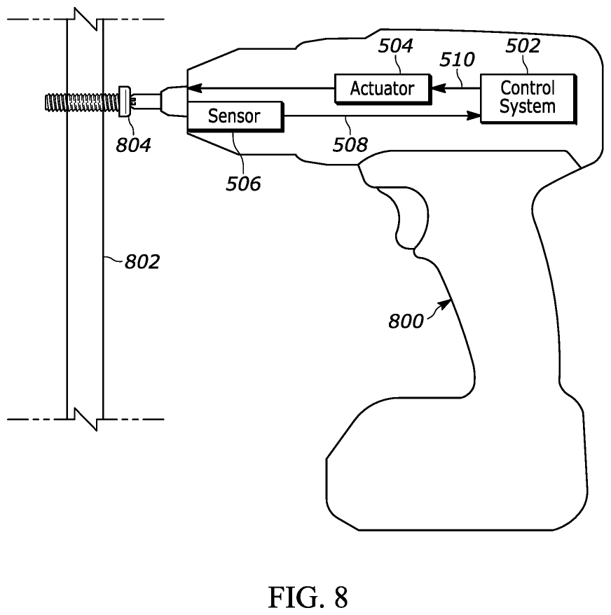

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

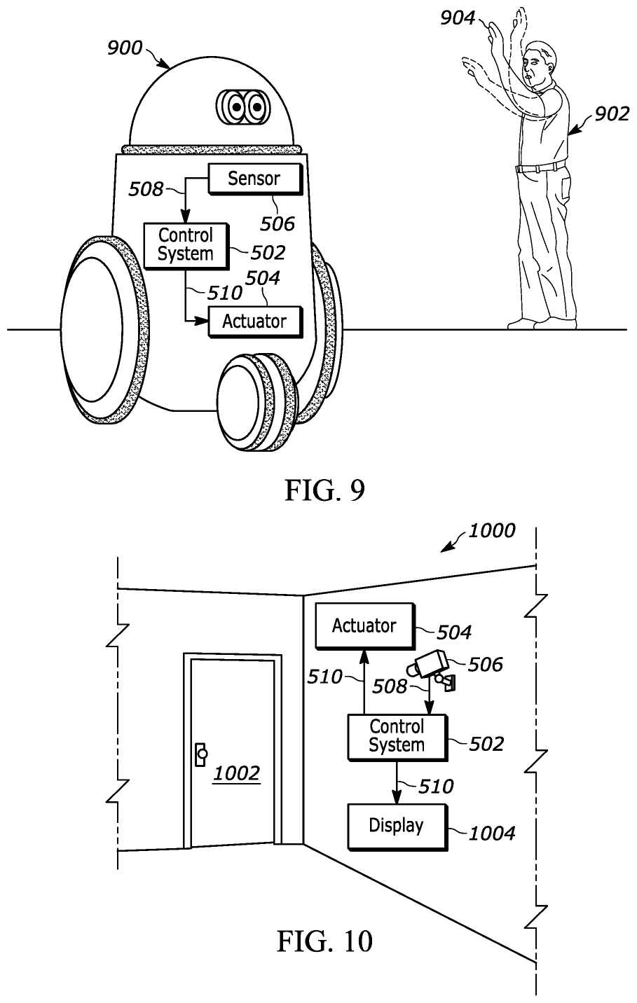

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

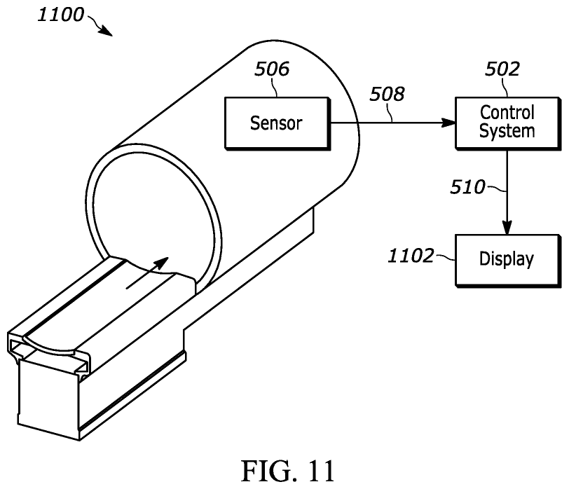

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of training a machine learning (ML) model, the method comprising:
obtaining a dataset that includes (i) first training data obtained using two or more ground truth sensing systems and (ii) second training data obtained using a prediction sensing system configured to implement the ML model;
determining a loss function based on the first training data, wherein the loss function defines a region of zero loss based on a minimum and a maximum of the first training data;
calculating, using the ML model, a prediction output based on the second training data;
calculating, using the loss function, a loss of the ML model based on the prediction output; and
updating the ML model based on the calculated loss.

2. The method of claim 1, wherein the ground truth sensing systems include at least one of a camera system, a radar system, and a photocell system and the prediction sensing system includes at least one audio sensor.

3. The method of claim 1, wherein the ML model is configured to detect features in an audio stream of data.

4. The method of claim 1, wherein determining the loss function includes defining the region of zero loss between a lower bound based on the minimum of the first training data and an upper bound based on the maximum of the first training data.

5. The method of claim 1, further comprising determining a correctness function based on the first training data, wherein the correctness function is configured to (i) output a first value in response to the prediction output being within a predetermined tolerance of the region of zero loss and (ii) output a second value in response to the prediction output not being within the predetermined tolerance of the region of zero loss.

6. The method of claim 5, further comprising calculating an accuracy of the ML model using the correctness function and updating the ML model further based on the calculated accuracy.

7. The method of claim 1, wherein (i) the two or more ground truth sensing systems are configured to visually detect an object in a first time interval and (ii) the prediction sensing system is configured to detect audio features associated with the object in the first time interval.

8. A system for training a machine learning (ML) model, the system comprising:
loss function circuitry configured to (i) receive a dataset that includes first training data obtained using two or more ground truth sensing systems and (ii) determine a loss function based on the first training data, wherein the loss function defines a region of zero loss based on a minimum and a maximum of the first training data; and
ML circuitry configured to implement the ML model, wherein implementing the ML model includes (i) receiving second training data obtained using a prediction sensing system configured to implement the ML model and (ii) calculating, using the ML model, a prediction output based on the second training data,
wherein the loss function circuitry is further configured to calculate, using the loss function, a loss of the ML model based on the prediction output, and
wherein the ML circuitry is configured to update the ML model based on the calculated loss.

9. The system of claim 8, wherein the ground truth sensing systems include at least one of a camera system, a radar system, and a photocell system and the prediction sensing system includes at least one audio sensor.

10. The system of claim 8, wherein the ML model is configured to detect features in an audio stream of data.

11. The system of claim 8, wherein, to determine the loss function, the loss function circuitry is configured to define the region of zero loss between a lower bound based on the minimum of the first training data and an upper bound based on the maximum of the first training data.

12. The system of claim 8, further comprising correctness function circuitry configured to determine a correctness function based on the first training data, wherein the correctness function is configured to (i) output a first value in response to the prediction output being within a predetermined tolerance of the region of zero loss and (ii) output a second value in response to the prediction output not being within the predetermined tolerance of the region of zero loss.

13. The system of claim 12, wherein the correctness function circuitry is configured to calculate an accuracy of the ML model using the correctness function, and wherein the ML circuitry is configured to and update the ML model further based on the calculated accuracy.

14. The system of claim 8, wherein (i) the two or more ground truth sensing systems are configured to visually detect an object in a first time interval and (ii) the prediction sensing system is configured to detect audio features associated with the object in the first time interval.

15. A computing device configured to implement and train a machine learning (ML) model, the computing device including a processing device configured to execute instructions stored in memory to:
obtain a dataset that includes (i) first training data obtained using two or more ground truth sensing systems and (ii) second training data obtained using a prediction sensing system configured to implement the ML model;
determine a loss function based on the first training data, wherein the loss function defines a region of zero loss based on a minimum and a maximum of the first training data;
calculate, using the ML model, a prediction output based on the second training data;
calculate, using the loss function, a loss of the ML model based on the prediction output; and
update the ML model based on the calculated loss.

16. A system comprising the computing device of claim 15 and further comprising the two or more ground truth sensing systems and the prediction sensing system, wherein the ground truth sensing systems include at least one of a camera system, a radar system, and a photocell system and the prediction sensing system includes at least one audio sensor.

17. The computing device of claim 15, wherein the ML model is configured to detect features in an audio stream of data.

18. The computing device of claim 15, wherein determining the loss function includes defining the region of zero loss between a lower bound based on the minimum of the first training data and an upper bound based on the maximum of the first training data.

19. The computing device of claim 15, wherein the processing device is further configured to execute instructions stored in memory to determine a correctness function based on the first training data, wherein the correctness function is configured to (i) output a first value in response to the prediction output being within a predetermined tolerance of the region of zero loss and (ii) output a second value in response to the prediction output not being within the predetermined tolerance of the region of zero loss, calculate an accuracy of the ML model using the correctness function, and update the ML model further based on the calculated accuracy.

20. The system of claim 15, wherein (i) the two or more ground truth sensing systems are configured to visually detect an object in a first time interval and (ii) the prediction sensing system is configured to detect audio features associated with the object in the first time interval.
